(19) United States
(12) Patent Application Publication
(10) Pub. No.: US 2025/0309498 A1
(43) Pub. Date: Oct. 2, 2025

(54) BATTERY PACK WITH ASYMMETRIC CELL TABS

(71) Applicant: Lenovo (Singapore) Pte. Ltd., Singapore (SG)

(72) Inventors: Bouziane Yebka, Apex, NC (US); Jeremy R. Carlson, Cary, NC (US); Philip J. Jakes, Durham, NC (US)

(21) Appl. No.: 18/622,501

(22) Filed: Mar. 29, 2024

(51) Int. Cl. H01M 50/547; H01M 50/289; H01M 50/566

(52) U.S. Cl. CPC H01M 50/547; H01M 50/289; H01M 50/566; H01M 2200/10

(57) ABSTRACT

A battery cell pack includes a first battery cell that has a first tab and a second tab. The battery cell pack also includes a second battery cell that includes its own first tab and second tab. The tabs of the two battery cells are offset from each other so that the battery cells can be positioned closer to each other, thereby freeing up space in the battery casing for more battery cells.

### TECHNICAL FIELD

Embodiments described herein generally relate to battery cells, and in an embodiment, but not by way of limitation, a battery cell including offset tabs to increase the capacity of the battery.

### BACKGROUND

Energy density of batteries has been increased over the years via cell component design, electrode compaction, current collector thickness reduction, and separator thickness reduction. However, despite these efforts, battery energy density, and in particular lithium-ion battery energy density, has approached theoretical limits.

### BRIEF DESCRIPTION OF THE DRAWINGS

In the drawings, which are not necessarily drawn to scale, like numerals may describe similar components in different views. Like numerals having different letter suffixes may represent different instances of similar components. Some embodiments are illustrated by way of example, and not limitation, in the figures of the accompanying drawings.

FIG. 1 is a diagram illustrating a plurality of embodiments of batteries with offset cell tabs.

FIG. 1A is a diagram illustrating a plurality of embodiments of batteries with offset cell tabs.

FIG. 2 is a diagram illustrating another embodiment of a battery cell with offset cell tabs.

FIG. 3 illustrates an embodiment of a battery cell with a combination of a battery cell tab and a thermal cutoff (TCO) device.

FIG. 4 is a diagram illustrating operations and features of manufacturing a battery cell pack having offset tabs.

FIG. 5 is a diagram illustrating operations and features of manufacturing a battery cell having offset tabs.

### DETAILED DESCRIPTION

An embodiment optimizes battery cell tab design by offsetting battery cells tabs in opposing cells. This tab offset increases the volume of cells in a battery pack, thereby optimizing the battery pack energy density of existing battery cell structures.

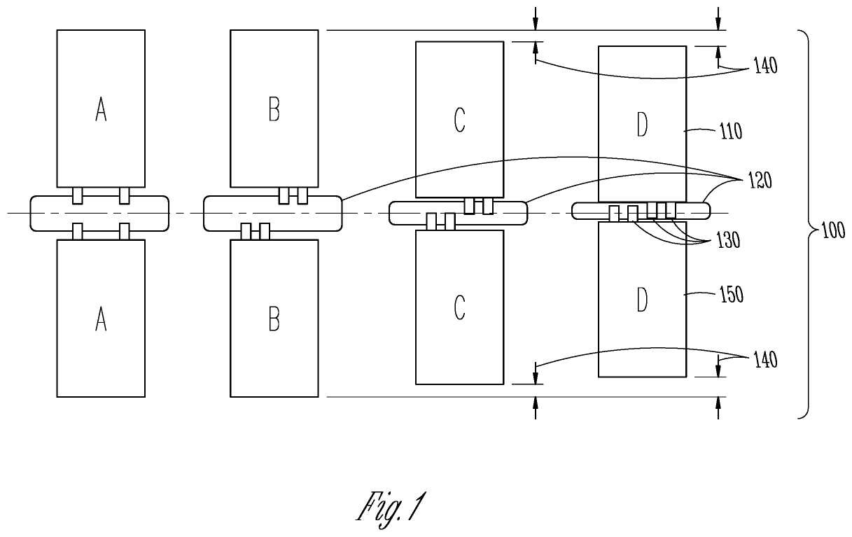

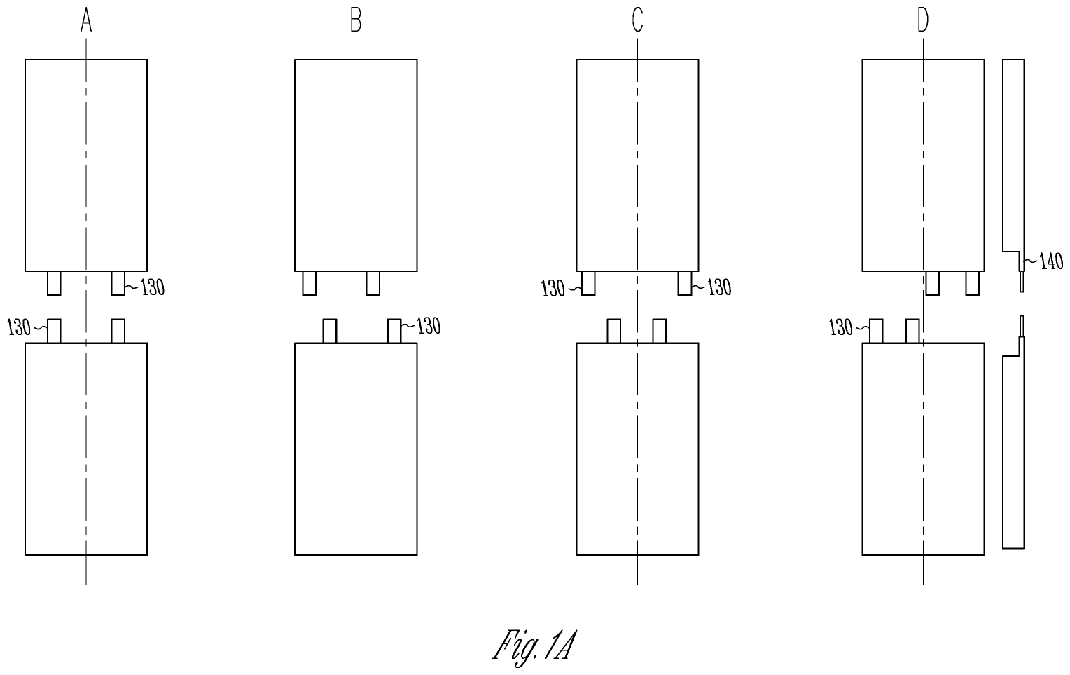

FIG. 1 is a diagram illustrating a plurality of embodiments B, C and D of battery cell packs 100 with offset cell tabs. First, embodiment A illustrates a battery cell pack that does not include offset tabs. The embodiment A includes cell pack 100 that has battery cells 110 and 150. As can be seen in embodiment A, battery cell 110 and battery cell 150 have tabs 130 that are directly opposite one another. The battery cell pack 100 further includes a battery management unit (BMU) 120.

Referring now to embodiments B, C and D, the battery cell tabs 130 are not directly opposite one another, but offset from one another. This allows the BMU 120 to occupy a smaller area, which creates free space 140 in the battery casing. This free space 140 can be filled with additional battery cell material, thereby increasing the energy density of the battery. The placement of the tabs in an offset manner can be done during a tab welding step of a cell assembly process. FIG. 1A illustrates additional embodiments of battery cell packs having offset tabs 130. And like in FIG. 1, moving the battery packs in FIG. 1A closer together creates free space 140.

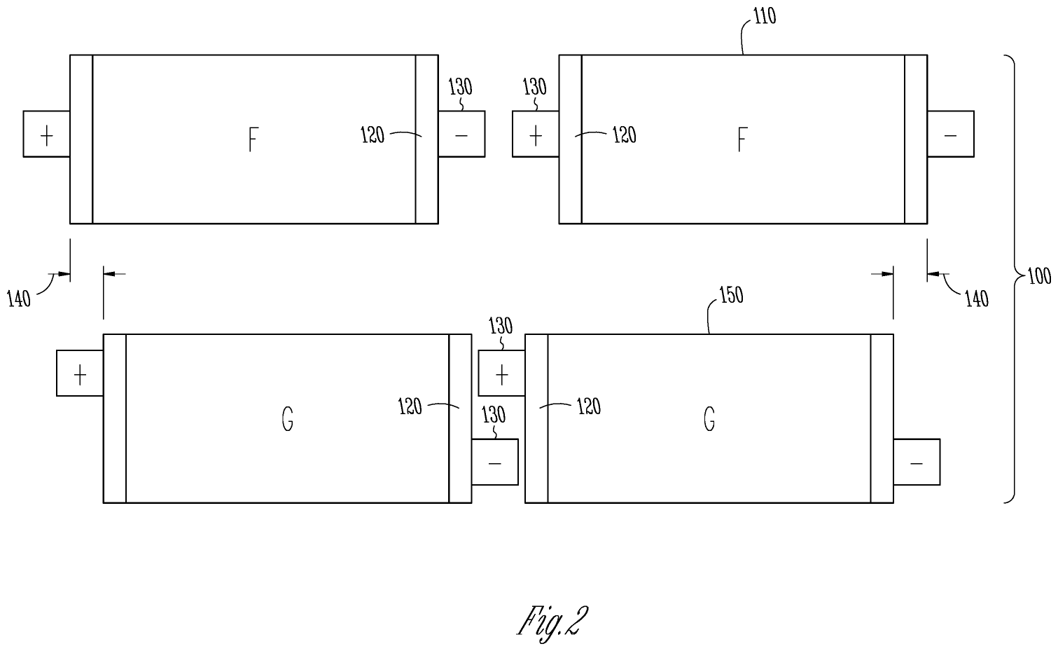

FIG. 2 is another diagram illustrating an embodiment of a battery cell with offset cell tabs. In the embodiment of FIG. 2, two battery cells are arranged in line along the same longitudinal axis. In embodiment F, the cell tabs 130 are, like the cells themselves, aligned opposite each other along the same longitudinal axis. In embodiment G, the cell tabs 130 are offset from one another like in embodiments B, C and D of FIG. 1. And like in FIG. 1, this creates free space 140 that can be used for additional battery cell material, thereby increasing the energy density of the battery cell pack.

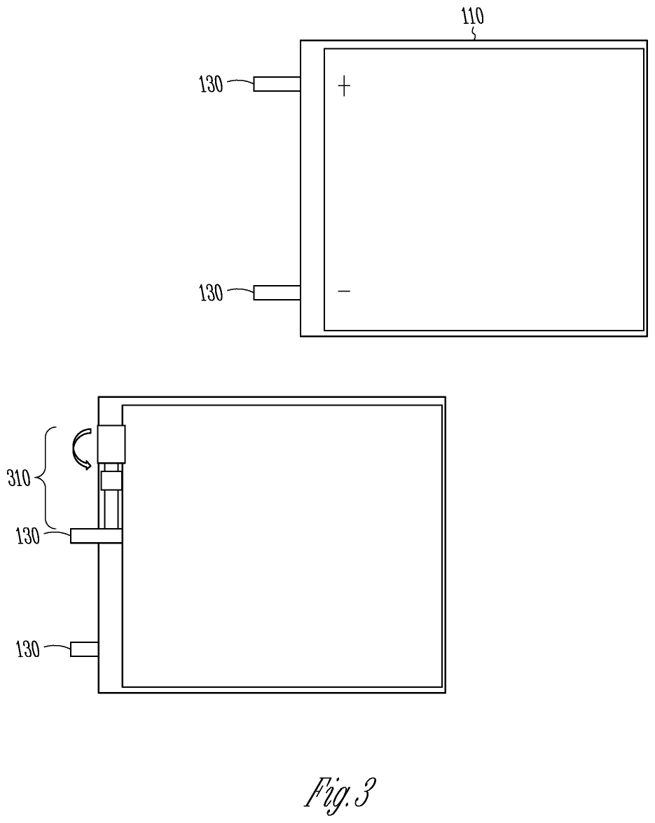

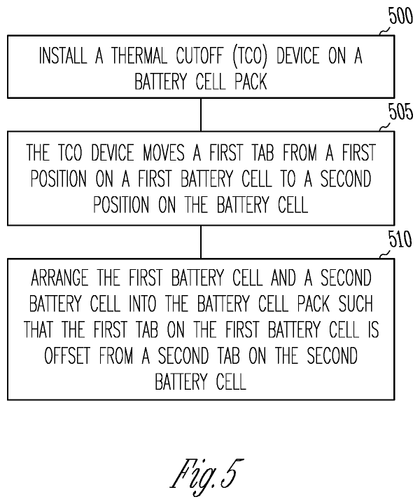

FIG. 3 illustrates an embodiment of a battery cell with a combination of a battery cell tab and a thermal cutoff (TCO) device. As further explained in FIG. 5 herein, FIG. 3 illustrates a battery cell pack wherein a cell tab 130 has be repositioned on the battery casing via the use of a thermal cutoff (TCO) device 310. The use of a TCO device 310 to reposition a cell tab 130 can be used to reposition the cell tab 130 after the manufacture of a battery cell, so that the battery cells in the battery cell pack can be offset from one another.

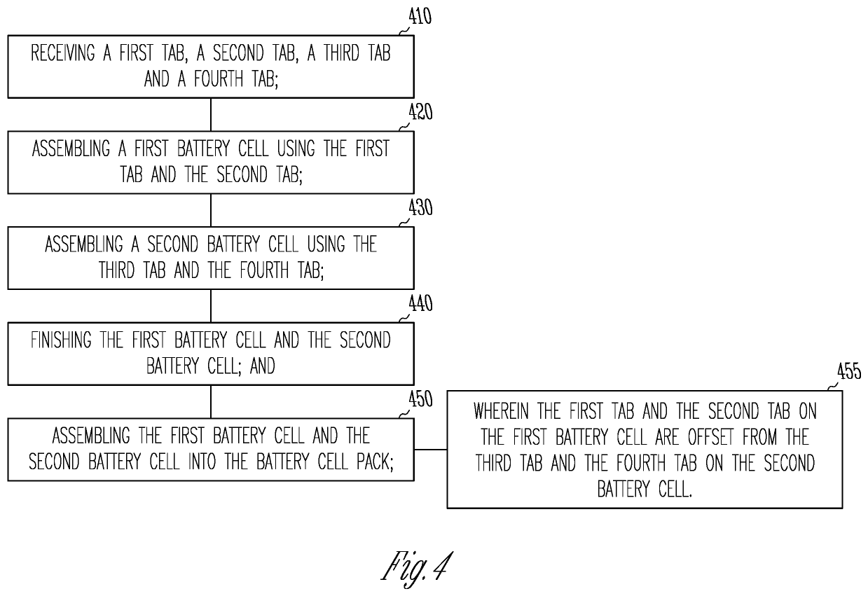

FIG. 4 is a diagram illustrating operations and features of manufacturing a battery cell pack having offset tabs. As indicated at 410, a first tab, a second tab, a third tab and a fourth tab are used in the manufacture of the battery cell pack. At 420, a first battery cell is assembled using the first tab and the second tab, and at 430, a second battery cell is assembled using the third tab and the fourth tab. At 440 the first battery cell and the second battery cell are finished, and at 450, the first battery cell and the second battery cell are assembled into the battery cell pack. As noted at 455, the first tab and the second tab on the first battery cell are offset from the third tab and the fourth tab on the second battery cell.

FIG. 5 is a diagram illustrating operations and features of manufacturing a battery cell having offset tabs. As indicated at 500, a thermal cutoff (TCO) device is installed on the battery cell pack. The TCO device moves a first tab from a first position on a first battery cell to a second position on the battery cell (505). At 510, the first battery cell and a second battery cell are arranged into the battery cell pack, such that the first tab on the first battery cell is offset from a second tab on the second battery cell.

### EXAMPLES

Example No. 1 is a battery cell pack comprising a first battery cell, the first battery cell comprising a first tab and a second tab; and a second battery cell, the second battery cell comprising a third tab and a fourth tab; wherein the first tab and the second tab are offset from the third tab and the fourth tab.

Example No. 2 includes all the features of Example No. 1, and optionally includes a battery cell pack wherein the offset decreases an area of a battery monitoring unit, thereby increasing an area in the battery cell pack for additional battery cells.

Example No. 3 includes all the features of Example Nos. 1-2, and optionally includes a battery cell pack wherein placement of the first tab, the second tab, the third tab, and the fourth tab occurs during a tab welding step of a cell assembly process.

Example No. 4 includes all the features of Example Nos. 1-3, and optionally includes a battery cell pack wherein placement of one or more of the first tab, the second tab, the third tab and the fourth tab occurs during an installation of a thermal cutoff (TCO) device welding step of a battery cell pack assembly process.

Example No. 5 includes all the features of Example Nos. 1-4, and optionally includes a battery cell pack wherein the battery cell pack comprises an outer casing.

Example No. 6 is a process of manufacturing a battery cell pack comprising receiving a first tab, a second tab, a third tab and a fourth tab; assembling a first battery cell using the first tab and the second tab; assembling a second battery cell using the third tab and the fourth tab; finishing the first battery cell and the second battery cell; and assembling the first battery cell and the second battery cell into the battery cell pack; wherein the first tab and the second tab on the first battery cell are offset from the third tab and the fourth tab on the second battery cell.

Example No. 7 is a process of remanufacturing a battery cell pack comprising installing a thermal cutoff (TCO) device on the battery cell pack, the TCO device moving a first tab from a first position on a first battery cell to a second position on the battery cell; and arranging the first battery cell and a second battery cell into the battery cell pack, such that the first tab on the first battery cell is offset from a second tab on the second battery cell.

The above detailed description includes references to the accompanying drawings, which form a part of the detailed description. The drawings show, by way of illustration, specific embodiments that may be practiced. These embodiments are also referred to herein as “examples.” Such examples may include elements in addition to those shown or described. However, also contemplated are examples that include the elements shown or described. Moreover, also contemplated are examples using any combination or permutation of those elements shown or described (or one or more aspects thereof), either with respect to a particular example (or one or more aspects thereof), or with respect to other examples (or one or more aspects thereof) shown or described herein.

Publications, patents, and patent documents referred to in this document are incorporated by reference herein in their entirety, as though individually incorporated by reference. In the event of inconsistent usages between this document and those documents so incorporated by reference, the usage in the incorporated reference(s) are supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to suggest a numerical order for their objects.

The above description is intended to be illustrative, and not restrictive. For example, the above-described examples (or one or more aspects thereof) may be used in combination with others. Other embodiments may be used, such as by one of ordinary skill in the art upon reviewing the above description. The Abstract is to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. However, the claims may not set forth every feature disclosed herein as embodiments may feature a subset of said features. Further, embodiments may include fewer features than those disclosed in a particular example. Thus, the following claims are hereby incorporated into the Detailed Description, with a claim standing on its own as a separate embodiment. The scope of the embodiments disclosed herein is to be determined with reference to the appended claims, along with the full scope of equivalents to which such claims are entitled.

1. A battery cell pack comprising:
a first battery cell, the first battery cell comprising a first tab and a second tab; and
a second battery cell, the second battery cell comprising a third tab and a fourth tab;
wherein the first tab and the second tab are offset from the third tab and the fourth tab.

2. The battery cell pack of claim 1, wherein the offset decreases an area of a battery monitoring unit, thereby increasing an area in the battery cell pack for additional battery cells.

3. The battery cell pack of claim 1, wherein placement of the first tab, the second tab, the third tab, and the fourth tab occurs during a tab welding step of a cell assembly process.

4. The battery cell pack of claim 1, wherein placement of one or more of the first tab, the second tab, the third tab and the fourth tab occurs during an installation of a thermal cutoff (TCO) device welding step of a battery cell pack assembly process.

5. The battery cell pack of claim 1, wherein the battery cell pack comprises an outer casing.

6. A process of manufacturing a battery cell pack comprising:
receiving a first tab, a second tab, a third tab and a fourth tab;
assembling a first battery cell using the first tab and the second tab;
assembling a second battery cell using the third tab and the fourth tab;
finishing the first battery cell and the second battery cell; and
assembling the first battery cell and the second battery cell into the battery cell pack;
wherein the first tab and the second tab on the first battery cell are offset from the third tab and the fourth tab on the second battery cell.

7. A process of remanufacturing a battery cell pack comprising:
installing a thermal cutoff (TCO) device on the battery cell pack, the TCO device moving a first tab from a first position on a first battery cell to a second position on the battery cell; and
arranging the first battery cell and a second battery cell into the battery cell pack, such that the first tab on the first battery cell is offset from a second tab on the second battery cell.
